(19) United States
(12) Patent Application Publication
(10) Pub. No.: US 2010/0191449 A1
(43) Pub. Date: Jul. 29, 2010

(54) PACKET TRAFFIC CONTROL SYSTEM

(76) Inventor: Shouzou Iwamoto, Osaka (JP)

Correspondence Address: RABIN & Berdo, PC, 1101 14TH STREET, NW, SUITE 500, WASHINGTON, DC, 20005, US

(21) Appl. No.: 12/671,480

(22) PCT Filed: Nov. 6, 2007
(86) PCT No.: PCT/JP2007/071518

§ 371 Date: Jan. 29, 2010

(30) Foreign Application Priority Data
Jul. 30, 2007 (JP) 2007-196923

(51) Int. Cl. G08G 1/09

(52) U.S. Cl. 701/118

(57) ABSTRACT

A traffic control system includes: a vehicle detection sensor (CS) for detecting a vehicle on a road; a traveling speed command indicator (VI) for indicating a traveling speed command to the vehicle on the road; a vehicle train detection means (104) for detecting a vehicle train in which vehicles range with each other within a predetermined inter-vehicle distance; a packet formation control means (106) for indicating a traveling speed command to form a packet having predetermined vehicle train length and inter-vehicle train distance for the vehicle on the road; a packet traveling control means (108) for indicating a traveling speed command so that the packets from respective direction can pass an intersection efficiently; and a traffic signal control means (114) for controlling a traffic signal in conjunction with a packet arriving at the intersection under control of the packet traveling control means. Since the system indicates a speed command to vehicles on the road to make the vehicles travel while forming a packet having the predetermined vehicle train length and the inter-vehicle train distance, unnecessary acceleration/deceleration can be suppressed to thereby not only achieve improvement of fuel consumption and suppression of environmental pollution, but also suppress occurrence of natural traffic jam.

### FIELD OF THE INVENTION

The present invention relates to a packet traffic control system which controls a traffic flow of vehicles on a road to prevent traffic jam from occurring.

### DESCRIPTION OF THE RELATED ART

As such a traffic control system, for example, Patent Document 1 discloses a road traffic flow control apparatus which measures road traffic volume on a road and a traveling speed of a vehicle, judges traffic condition such as traffic jam by using the measured traffic volume and traveling speed, decides what type of traffic flow control is to be made based on the obtained traffic condition; and based on a result of this, controls a traffic volume flowing into the road or controls a relevant traffic signal based on a traffic volume, traveling speed, and variation of traveling speed at a traffic bottleneck point and its vicinity, and this apparatus has been thought to resolve stop-and-go driving to reduce environmental pollution.

Moreover, for example, Patent Document 2 discloses a road traffic information communication system which includes intersection traffic signal information composed of at least a crossroad name, reference time of traffic signal information, a switching period of traffic signals, and a green signal period which permits passage of a vehicle in road traffic information from a traffic information center, and includes a green signal formation part for forming a green signal map which distinguishes green signal time of each intersection signal from yellow and red signal time thereof in a display terminal displaying information received from a VICS beacon where a distance of each intersection traffic signal from the VICS beacon is marked at a vertical axis and time elapsed from the VICS beacon is marked at a horizontal axis, and an optimum speed display part for calculating and displaying an optimum speed at which the vehicle can pass without stopping based on the green signal map, and this system has been thought to prevent traffic jam from occurring.
Patent Document 1: Japanese Patent Application Laid-Open No. H6-28597
Patent Document 2: Japanese Patent Application Laid-Open No. H7-93692

### SUMMARY OF THE INVENTION

### Problem to be Solved by the Invention

However, the road traffic flow control apparatus in the above Patent Document 1 only restricts the traffic volume that flows in by controlling the traffic signal according to the jam condition, which causes new traffic jam in a zone where it is blocked to flow in, as long as there exists vehicles hoping for traveling in the zone concerned, thus finding no thoroughgoing solution to the natural traffic jam.

On the other hand, the road traffic information communication system disclosed in the above Patent Document 2 obtains and displays the optimum speed at which the vehicle can pass the intersection within a green signal period based on the traffic signal information at each crossroad. However, since the vehicle practically cannot necessarily travel at the designated optimum speed in relation to other vehicles, it is difficult to prevent the traffic jam from occurring, even if such means is included.

In general, natural traffic jam occurs in the following manner except for a case where traffic is shut off by an accident or construction. With an increase of traffic volume, a long vehicle train is formed. When a preceding vehicle in the vehicle train reduces its traveling speed, a brake is stepped on in the following vehicle. This is spread to the subsequent vehicles and thereby amplified. Eventually, stop-and-go driving must be repeated to travel.

Such a phenomenon is attributable to that the formation of the long vehicle train with traveling vehicles results in no spatial allowance for resolving initially produced minor speed change.

Accordingly, it is thought that guiding the vehicles traveling on the road so as to provide a space of a predetermined length for every vehicle train of a predetermined length and then making the vehicles travel while forming a vehicle train having a predetermined vehicle train length and a predetermined inter-vehicle train distance (hereinafter referred to as “packet”) can suppress unnecessary stop and go and/or acceleration and deceleration, and as a result, can suppress occurrence of natural traffic jam. However, in the conventional traffic control system, an idea of control condition of the traveling vehicle train is not found to suppress the occurrence of natural traffic jam.

It is an object of the present invention to provide a traffic control system capable of indicating a speed command to a vehicle on a road to make the vehicle travel while forming a packet having a predetermined vehicle train length and a predetermined inter-vehicle train distance and thus suppress unnecessary stop and go and/or acceleration and deceleration to thereby not only achieve improvement of fuel efficiency, suppression of environmental pollution and reduction of traffic noise, but also suppress occurrence of natural traffic jam and prevent occurrence of traffic accidents associated with frustrated driving, etc.

### Means for Solving Problem

A packet traffic control system according to the present invention includes a vehicle detection means disposed along a road for detecting a vehicle on the road, a traveling speed command indication means disposed along the road for indicating a traveling speed command to the vehicle on the road, a vehicle train detection means for detecting a vehicle train in which vehicles detected by the vehicle detection sensor range with each other within a predetermined length, and a packet formation control means for indicating a traveling speed command so that the vehicle train detected by the vehicle train detection means forms a packet having a predetermined vehicle train length and a predetermined inter-vehicle train distance to the vehicle on the road by the traveling speed command indication means.

According to the invention, since the vehicle detection means for detecting a vehicle on the road and the traveling speed command indication means for indicating a traveling speed command to the vehicle on the road are included and the traveling speed command is indicated to the traveling vehicle so that the vehicle train detected by the vehicle train detection means forms the packet having the predetermined vehicle train length and the predetermined inter-vehicle train distance by the packet formation control means, the vehicle on the road is guided to travel while forming the packet having the predetermined vehicle train length and the predetermined inter-vehicle train distance, which can suppress unnecessary stop and go and/or acceleration and deceleration.

Here, the predetermined vehicle train length is a length with which significant acceleration and deceleration do not occur in a following vehicle in response to speed change occurring in a preceding vehicle during normal travel, and the predetermined inter-vehicle train distance is a distance with which speed change in a preceding packet does not affect the following packet. They may be fixed lengths on the basis of experimental rules or may be varied according to a traffic volume measured by the vehicle detection means or the like, as needed.

Alternatively, with reference to a standard traffic signal, a length of a vehicle train which can pass during a green signal period at a designated standard traveling speed may be set as the predetermined vehicle train length, and a distance in which a following packet traveling at the standard traveling speed reaches the traffic signal after elapse of a red signal period after the preceding packet passed the traffic signal may be set as the predetermined inter-vehicle train distance.

Furthermore, the predetermined vehicle train length and the predetermined inter-vehicle train distance are not limited to particular lengths, and may be used with a certain range.

The packet traffic control system according to the present invention may include a standard traveling speed determination means for determining a standard traveling speed in each travel direction based on a number of vehicles detected by the vehicle detection means per predetermined time period, wherein the packet formation control means may include a function of indicating the standard traveling speed in the travel direction determined by the standard traveling speed determination means as an initial traveling speed command to vehicles within the predetermined vehicle train length from a head of a vehicle train and indicating a decelerating speed command so as to form the predetermined inter-vehicle train distance from the preceding vehicle train to following vehicles beyond the predetermined vehicle train length from the head of the vehicle train by the traveling speed command indication means, when the vehicle train having a longer length than the predetermined length is detected by the vehicle train detection means when a vehicle is detected by the vehicle detection means.

According to the invention, since the standard traveling speed is determined according to traffic volume by the standard traveling speed determination means, and in the packet formation control means, when a vehicle train having a longer length than the predetermined length is detected when a vehicle is detected, the speed command of the standard traveling speed is indicated as an initial traveling speed command to vehicles ranging in the predetermined length from a head of a vehicle train, and a decelerating speed command so as to form the predetermined inter-vehicle train distance from the preceding vehicle train is indicated to following vehicles beyond the predetermined vehicle train length from the head of the vehicle train, the traveling vehicles can be guided to travel at an optimum traveling speed according to the traffic volume while forming a packet having the predetermined vehicle train length and the predetermined inter-vehicle train distance.

In the packet traffic control system according to the present invention, the function of indicating a decelerating speed command so as to form the predetermined inter-vehicle train distance may compute and indicate a traveling speed at which the predetermined inter-vehicle train distance is formed at the next vehicle detection means disposed in the traveling direction to the vehicles beyond the predetermined vehicle train length from the head of vehicle train.

According to the invention, since the traveling speed at which the predetermined inter-vehicle train distance is formed at the next vehicle detection means disposed in the traveling direction is indicated to the vehicles beyond the predetermined vehicle train length from the head of the vehicle train, a packet having the predetermined inter-vehicle train distance from the preceding packet can be adequately formed by disposing the vehicle detection means and the traveling speed command indication means at an appropriate interval.

In the packet traffic control system according to the present invention, the packet formation control means may include a function of computing and indicating a traveling speed at which following vehicles catch up a preceding vehicle train at the next vehicle detection means disposed in the traveling direction to following vehicles within a certain range by the traveling speed command indication means, when the vehicle train having a longer length than the predetermined length is not detected by the vehicle train detection means.

According to the invention, since the traveling speed at which the following vehicles catch up with the preceding vehicle train at the next vehicle detection means is indicated to following vehicles within the certain range when the vehicle train having a longer length than the predetermined length is not detected, a packet having the predetermined vehicle train length can be efficiently formed by disposing the vehicle detection means and the traveling speed command indication means at an appropriate interval.

The packet traffic control system according to the present invention may include an intersection passage time notification table for notifying time at which a packet from each direction passes at each intersection and include a packet traveling control means including a function of computing passage time at which a packet passes a next intersection when the packet travels at the indicated traveling speed, when the packet is detected by the vehicle train detection means, a function of registering the computed passage time into the intersection passage time notification table for the intersection, when no packet overlapping with the computed passage time is registered, a function of modifying the computed passage time to passage time not overlapping with a packet in the orthogonal direction, registering the modified passage time into the intersection passage time notification table for the intersection, and then indicating a traveling speed command at which the packet passes the intersection at the modified passage time to the vehicles forming the packet by the traveling speed command indication means, when the packet overlapping with the computed passage time is registered in the orthogonal direction, and a function of modifying the computed passage time to passage time overlapping with the packet in the orthogonal direction for a longest possible period, registering the modified passage time into the intersection passage time notification table for the intersection, and then indicating a traveling speed at which the packet passes the intersection at the modified passage time to the vehicles forming the packet by the traveling speed command indication means, when a packet overlapping with the computed passage time is registered in an opposite direction, and may include a traffic signal control means for controlling the traffic signals at each intersection based on the passage time of the packet from each direction registered in the intersection passage time notification table.

According to the invention, passage time at which the detected packet passes the next intersection is computed and notified to the intersection passage time notification table when the packet is detected by the vehicle train detection means, the passage time in the intersection passage time notification table is modified so that it does not overlap with a packet at each intersection from the orthogonal direction, the speed command is indicated so that the detected packet can pass the intersection at the modified time, and the traffic signals at each intersection are controlled according to the intersection passage time notification table thereof, thereby the vehicles traveling while forming a predetermined packet can efficiently pass each intersection. Moreover, this gives a driver a strong incentive to observe the speed command, which promotes packet formation and exerts effects of the present invention more efficiently.

The packet traffic control system according to the present invention may include a packet detection table in which at least detection time and a speed command of the packet detected by the vehicle train detection means are registered, wherein the packet traveling control means may include a function of retrieving passage time of a corresponding packet registered in the intersection passage time notification therefrom, where a previous packet registered in the packet detection table for the preceding vehicle detection means disposed in front of the vehicle detection means detecting the present packet in the traveling direction is assumed as the corresponding packet when the detection time of the present packet detected by the vehicle train detection means is within a predetermined range with reference to estimated arrival time of the previous packet to the vehicle detection means detecting the present packet where the estimated arrival time is computed based on detection time and a speed command thereof, a function of indicating a traveling speed command to the vehicles forming the present packet so as to pass the intersection at the retrieved passage time by the traveling speed command indication means when the present packet can pass the intersection at the retrieved passage time, and a function of modifying the passage time in the intersection passage time notification table to closest passage time within a possible range and indicating a traveling speed command to the vehicles forming the present packet so as to pass the intersection at the modified passage time by the traveling speed command indication means when the present packet cannot pass the intersection at the retrieved passage time.

According to the invention, since detection time and an indicated speed command of a packet detected in each vehicle detection means are registered into the packet detection table, when it is confirmed that the detected packet corresponds to a previous packet detected in front in the traveling direction, a traveling speed command is indicated to the vehicles forming the present packet so as to pass the intersection at the passage time registered in the intersection passage time notification table for the previous packet detected in front, even when a packet detected in preceding vehicle detection means is continuously detected in a next vehicle detection means, the packet can pass the intersection efficiently by indicating an adequate speed command to the packet.

Note that the packet detection table is not necessarily provided separately from the intersection passage time notification table, information on a location where the packet has been detected, detection time, and a speed command may be recorded when registering passage time into the intersection passage time notification table.

In the packet traffic control system according to the present invention, the packet traveling control means may include a function of repeatedly modifying passage time of a packet in the orthogonal direction to passage time not causing overlapping until overlapping of passage time with a new packet in the orthogonal direction no longer occurs when overlapping with passage time of the packet in the orthogonal direction occurs as a result of modifying passage time in the intersection passage time notification table,.

According to the invention, even when overlapping with passage time of a packet in the orthogonal direction has occurred as a result of modifying passage time of a packet registered in the intersection passage time notification table since it can no longer be maintained at the following vehicle detection means, modifying the passage time of the packet in the orthogonal direction to passage time not causing overlapping is automatically repeated until overlapping with a new packet in the orthogonal direction no longer occurs, thereby even when delay or the like due to traffic condition occurs in the traveling packet, intersection passage time is automatically adjusted, and the vehicles traveling while forming the packet are controlled as a whole so that the vehicles can efficiently pass each intersection.

In the packet traffic control system according to the present invention, the traffic signal control means may include a function of indicating go-straight permission with a traffic signal for vehicle in the passage time of the packet in the same direction and indicating right-turn permission with the traffic signal for vehicle when passage time of a packet in the opposite direction is not registered in the passage time of the packet in the same direction, when passage time of a packet in the same direction as that of the traffic signal for vehicle is registered in the intersection passage time notification table.

According to the invention, since each traffic signal is controlled so that going straight is permitted when there is no packet in the orthogonal direction and right turn is permitted when there is no packet in the orthogonal direction and no packet in the opposite direction, during the packet passage time, the vehicles traveling while forming the packet can efficiently pass each intersection.

The packet traffic control system according to the present invention may include a pedestrian detection means disposed at each intersection for detecting a pedestrian crossing the intersection, wherein the traffic signal control means may include a function of indicating go-straight permission with a traffic signal for vehicle in passage time of a packet in the same direction as that of the traffic signal for vehicle, a function of indicating right-turn permission with the traffic signal for vehicle when it is not in passage time of a packet in the opposite direction but a traffic signal for pedestrian on a right-turn side in the same direction as that of the traffic signal for vehicle is red in the passage time of the packet in the same direction, a function of indicating left-turn permission with the traffic signal for vehicle when a traffic signal for pedestrian on a left-turn side in the same direction as that of the traffic signal for vehicle is red in the passage time of the packet in the same direction, a function of indicating green signal with a traffic signal for pedestrian on a right-turn side in the same direction as that of the traffic signal for vehicle when a pedestrian on the right-turn side in the same direction is detected by the pedestrian detection means in the passage time of the packet in the same direction, and a function of indicating green signal with a traffic signal for pedestrian on a left-turn side in the same direction as that of the traffic signal for vehicle when a pedestrian on the left-turn side in the same direction is detected by the pedestrian detection means in the passage time of the packet in the same direction, when the passage time of the packet in the same direction is registered in the intersection passage time notification table.

According to the invention, since each traffic signal is controlled so that in the passage time of the packet, going straight is permitted when there is no packet in the orthogonal direction, right-turn is permitted when there is no packet in the orthogonal direction, no packet in the opposite direction, and the traffic signal for pedestrian is red, and left-turn is permitted when there is no packet in the orthogonal direction and the traffic signal for pedestrian on the right-turn side is red, the vehicles forming the packet can efficiently pass each intersection while adapting to the condition of pedestrians crossing the intersection.

The packet traffic control system according to the present invention may include a packet traveling control means including a function of computing a traveling speed at which a vehicle can pass a next intersection while the traffic signal is green and indicating the computed traveling speed command to the vehicles forming a packet by the traveling speed command indication means, when the packet is detected by the vehicle train detection means.

According to the invention, since the function of indicating the speed command so that vehicles forming a packet can pass each intersection while the traffic signal is green is included, even when the traffic signal at each intersection is controlled by a specific cycle, the vehicles forming the packet can efficiently pass each intersection.

### Advantages of the Invention

According to the present invention, the system has advantages of suppressing unnecessary stop and go and/or acceleration and deceleration to thereby not only achieve improvement of fuel efficiency, suppression of environmental pollution and reduction of traffic noise, but also suppress occurrence of natural traffic jam to prevent occurrence of traffic accidents associated with frustrated driving, etc.

The above object, other objects, features, and advantages of the present invention will be more clarified by description of best modes for carrying the invention provided hereinafter with reference to the accompanying drawings.

### BRIEF DESCRIPTION OF THE DRAWINGS

FIG. 1 is a system configuration diagram of a packet traffic control system according to one preferred embodiment of the present invention.

FIG. 2 is a diagram showing an example of on-road device arrangement of the packet traffic control system according to the embodiment of the present invention.

FIG. 3 is a diagram showing an example of a packet detection table in the packet traffic control system according to the embodiment of the present invention.

FIG. 4 is a diagram showing an example of an intersection passage time notification table in the packet traffic control system according to the embodiment of the present invention.

FIG. 5 is a diagram showing an example of a procedure of a packet formation control means in the packet traffic control system according to the embodiment of the present invention.

FIG. 6 is a diagram (Part 1) showing an example of a procedure of a packet traveling control means in the packet traffic control system according to the embodiment of the present invention.

FIG. 7 is a diagram (Part 2) showing an example of the procedure of the packet traveling control means in the packet traffic control system according to the embodiment of the present invention.

FIG. 8 is a diagram showing an example of control logic of a traffic signal control means in the packet traffic control system according to the embodiment of the present invention.

FIG. 9 is a diagram showing an example of a procedure of the packet traveling control means in the packet traffic control system according to another preferred embodiment of the present invention (in a case where the traffic signals are fixedly controlled).

### DESCRIPTION OF REFERENCE NUMERALS

100 Packet traffic control device

102 Standard traveling speed determination means

104 Vehicle train detection means

106 Packet formation control means

108 Packet traveling control means

110 Traveling speed command indicator control means

112 Pedestrian grasping means

114 Traffic signal control means

120 Packet traffic control data base

CS Vehicle detection sensor

WS Pedestrian detection sensor

VI Traveling speed command indicator

SC Traffic signal for vehicle

SW Traffic signal for pedestrian

### DESCRIPTION OF PREFERRED EMBODIMENTS

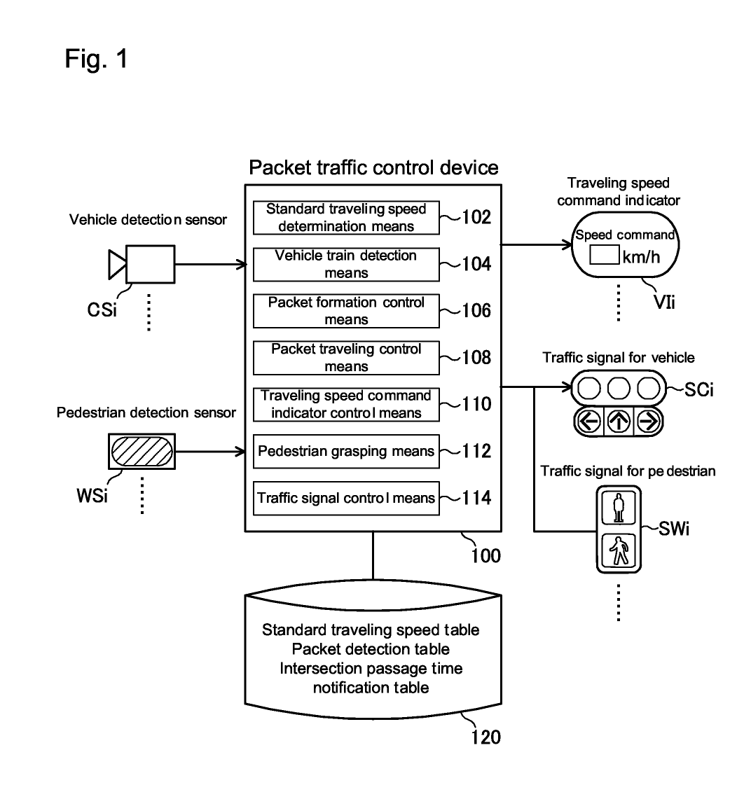

FIG. 1 shows a system configuration of a packet traffic control system according to one preferred embodiment of the present invention. As shown in the figure, this system includes a vehicle detection sensor CSi disposed along a road for detecting a vehicle on the road a pedestrian detection sensor WSi disposed at each intersection for detecting a pedestrian crossing the intersection; a traveling speed command indicator VIi disposed along the road for indicating a traveling speed command to the vehicle on the road a traffic signal for vehicle SCi disposed at each intersection a traffic signal for pedestrian SWi disposed at each intersection and a packet traffic control device 100 which guides the vehicle on the road to travel while forming a packet having a predetermined vehicle train length and a predetermined inter-vehicle train distance and which also performs control so that the formed packet can efficiently pass the intersection.

The vehicle detection sensor CSi detects a vehicle on the road, and as described below, since a vehicle train in which vehicles range with each other within a certain inter-vehicle distance is detected based on information from the vehicle detection sensor, a television camera is used as the sensor in this embodiment. The television camera is installed so as to take a bird's eye view of the vehicle on the road from above the road, opposing a traveling direction thereof.

Alternatively, an ultrasonic sensor or a high-frequency sensor may be used to detect the vehicle on the road as the vehicle detection sensor, and the vehicle train may be detected based on vehicle temporal continuity or spatial continuity detected by this. Still alternatively, by combining the ultrasonic sensor or the like and the television camera, the vehicle may be detected by the ultrasonic sensor or the like and the vehicle train may be detected by the television camera.

The pedestrian detection sensor WSi detects a pedestrian crossing an intersection, and in this embodiment, an electric wave type sensor is set above a sidewalk part in front of a pedestrian crosswalk at the intersection. Alternatively, an ultrasonic sensor or an infrared sensor may be used. Still alternatively, the pedestrian may be detected from an image of a television camera.

The traveling speed command indicator VIi indicates a traveling speed command through numerical display to a vehicle driver traveling on the road. In this embodiment, the traveling speed command indicator VIi indicates the traveling speed command to a vehicle detected by each vehicle detection sensor CSi, and thus is so provided as to form a pair with each vehicle detection sensor and is disposed ahead thereof in the traveling direction by a predetermined distance.

The packet traffic control device 100 indicates a traffic speed command to a vehicle detected by the vehicle detection sensor CSi by the traveling speed command indicator Vii to thereby guide the vehicle to travel while forming a packet having a predetermined vehicle train length and a predetermined inter-vehicle train distance, and also indicates an adequate speed command to vehicle forming a packet by the traveling speed command indicator VIi to thereby guide the vehicle to successfully pass a next intersection, and also controls the traffic signal for vehicle SCi and the traffic signal for pedestrian SWi at each intersection based on passage time of a packet from each direction and pedestrian information detected by the pedestrian detection sensor WSi to thereby make the vehicle forming the packet travel efficiently.

The packet traffic control device 100 includes a standard traveling speed determination means 102 for determining an optimum traveling speed in accordance with a traffic volume in each traveling direction, a vehicle train detection means 104 for detecting a vehicle train in which vehicles range with each other within a predetermined inter-vehicle distance when the vehicle has been detected on the road by the vehicle detection sensor CSi, a packet formation control means 106 for indicating a speed command by the traveling speed command indicator VIi so that the vehicle train detected by the vehicle train detection means forms a packet having a predetermined vehicle train length and a predetermined inter-vehicle train distance, a packet traveling control means 108 for determining passage time at the next intersection by adjusting passage time of a packet from each direction and then indicating a speed command by the traveling speed command indicator VIi so that the vehicle can pass the next intersection at the determined passage time, a traveling speed command indicator control means 110 for conducting each traveling speed command indicator VIi disposed on the road to indicate the specified speed command, a pedestrian grasping means 112 for detecting presence of a predetermined volume of pedestrians in each crossing direction based on information from the pedestrian detection sensor WSi disposed at each intersection, and a traffic signal control means 114 for controlling the traffic signal for vehicle SCi and the traffic signal for pedestrian SWi based on the passage time of the packet at each intersection determined in the packet traveling control means 108 and based on pedestrian condition at each intersection provided by the pedestrian grasping means 112.

Moreover, in order to perform the control described above, the packet traffic control device 100 includes a packet traffic control data base 120 including a standard traveling speed table where a standard traveling speed in each traveling direction determined by the standard traveling speed determination means 102 is registered, a packet detection table where detection time of a packet detected in the packet formation control means 106 and a speed command for the packet are registered for each vehicle detection sensor CSi, and an intersection passage time notification table for notifying and adjusting passage time of a packet from each direction for each intersection.

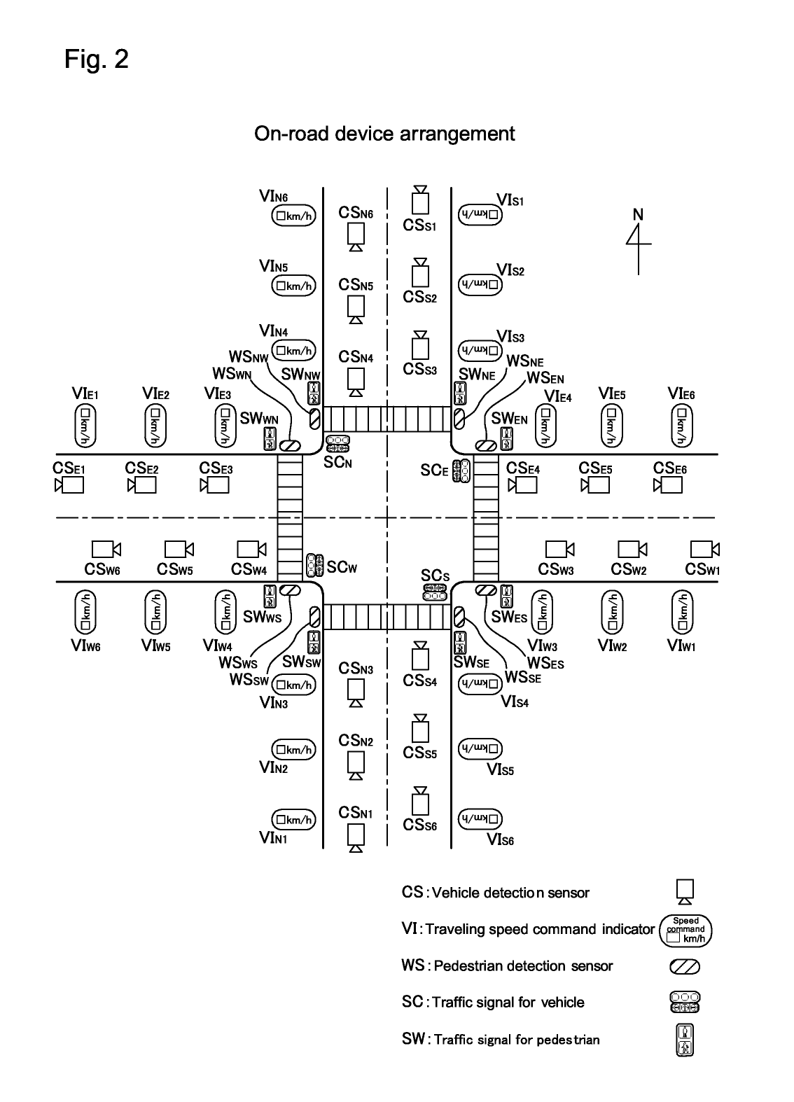

FIG. 2 shows on-road device arrangement of the packet traffic control system according to one preferred embodiment of the present invention. As shown in the figure, along respective traveling direction of the road, vehicle detection sensors CS_{E1} to CS_{E6}, CS_{W1} to CS_{W6}, CS_{S1} to CS_{S6} and CS_{N1} to CS_{N6}, and traveling speed command indicators VI_{E1} to VI_{E6}, VI_{W1} to VI_{W6}, VI _{S1} to VI_{S6} and VI_{N1} to VI_{N6} are provided, and the packet traffic control device 100 indicates a traveling speed command to a vehicle detected by each vehicle detection sensor CSi by the corresponding traveling speed command indicator VIi.

Also provided at each intersection are traffic signals for vehicle SC_{E}, SC_{W}, S_{CS} and S_{CN}, traffic signals for pedestrian SW_{ES}, SW_{EN}, SW_{WS}, SW_{WN}, SW_{SE}, SW_{SW}, SW_{NE} and SW_{NW}, and pedestrian detection sensors WS_{ES}, WS_{EN}, WS_{WS}, WS_{WN}, WS_{SE}, WS_{SW}, WS_{NE} and WS_{NW} for detecting pedestrians crossing the intersection in respective direction, which are controlled by the packet traffic control device 100.

In FIG. 2, a case is illustrated where three vehicle detection sensors CSi and traveling speed command indicators VIi corresponding thereto are provided at each of front and back of the intersection, but the number of vehicle detection sensors and traveling speed command indicators to be disposed are arbitrary.

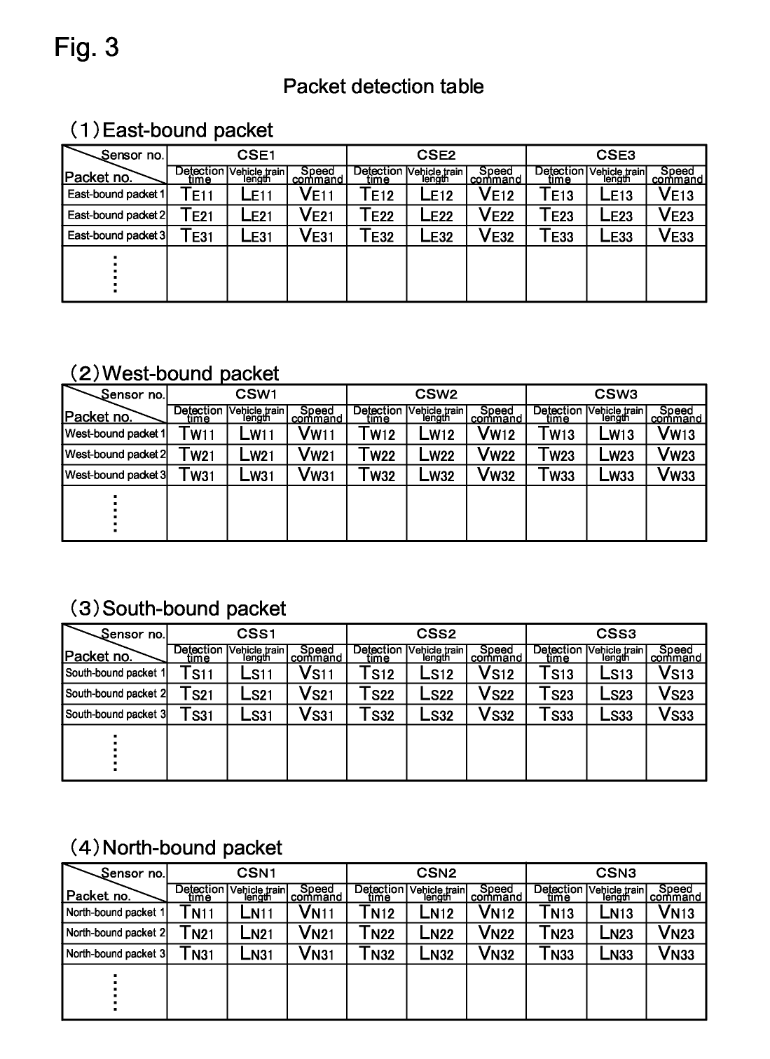

FIG. 3 shows an example of the packet detection table provided in the data base 120 of the packet traffic control device. The packet detection table is provided for each packet direction, and when a packet has been detected by the vehicle train detection means 104, detection time at which this packet was detected, a vehicle train length of the packet, and an indicated speed command specified by the packet traveling control means 108 to the packet are registered for each vehicle detection sensor disposed on the road in each direction.

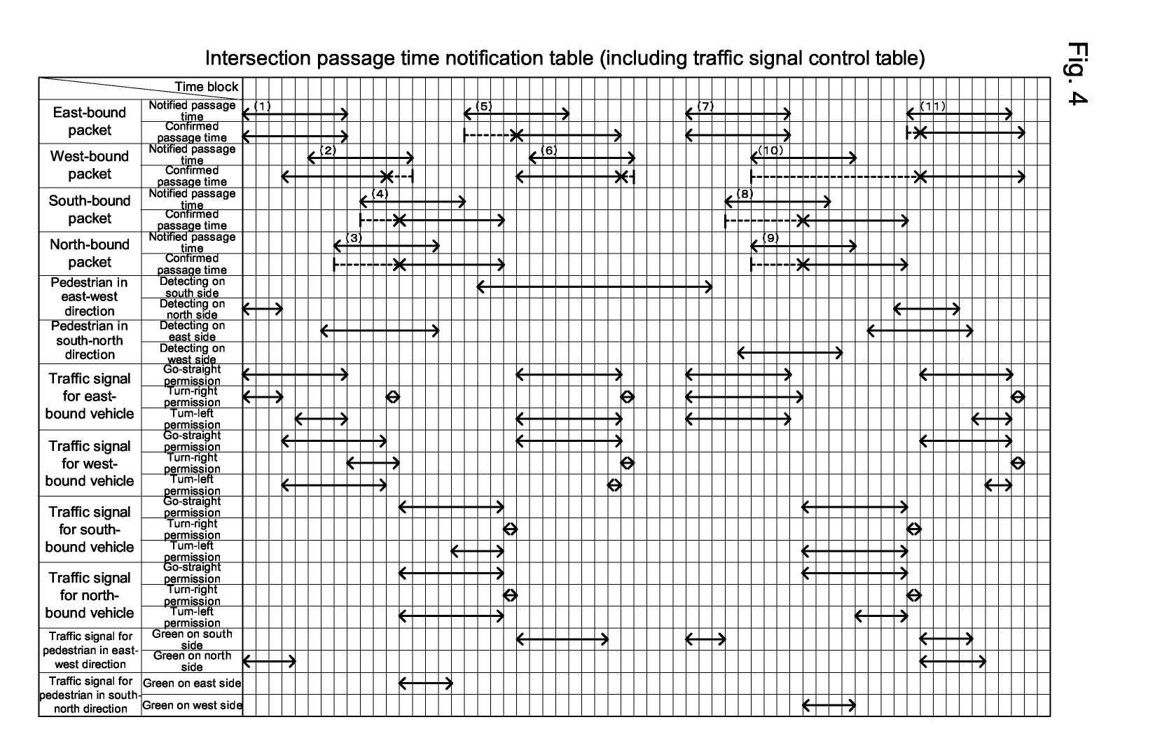

FIG. 4 shows an example of the intersection passage time notification table provided in the data base 120 of the packet traffic control device. The intersection passage time notification table is provided for each intersection, and when a packet has been detected by the vehicle train detection means 104, time at which the detected packet passes the corresponding intersection is estimated and registered as notified passage time for each direction, and its object is adjusting the notified passage time of the packet from each direction to determine confirmed passage time that permits its actual passage through the intersection.

Note that in FIG. 4, in order to recognize how to control the traffic signals at the intersection simultaneously while adjusting the passage time of the packet from each direction, a traffic signal control table together with the intersection passage time notification table is described which illustrates how each of the traffic signals is indicated based on the confirmed passage time.

Description will be given later concerning how the passage time notified for the packet from each direction is adjusted to confirm the passage time based on the intersection passage time notification table and how the traffic signals are controlled based on the confirmed passage time.

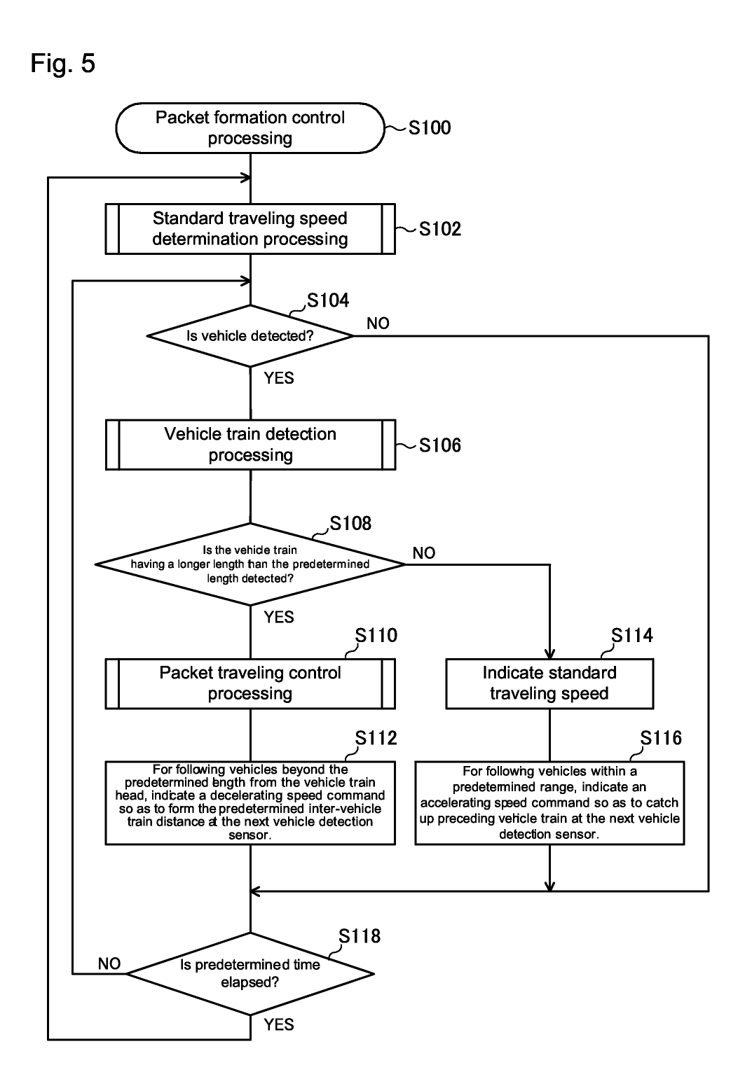

FIG. 5 shows procedures of packet formation control processing S100 executed as the packet formation control means 106 in the packet traffic control device 100.

As shown in the figure, the packet formation control processing S100 first performs standard traveling speed determination processing executed as the standard traveling speed determination means 102 (S102).

The standard traveling speed determination processing measures a traffic volume for each direction and for each fixed zone, determines a standard traveling speed for each direction based on the measured traffic volume, and registers it into the standard traveling speed table of the packet traffic control data base 120. For this, for example, an average number of vehicles per predetermined time detected by the vehicle detection sensor in each direction may be obtained and the standard traveling speed for each direction may be determined with reference to the standard traveling speed table where relationship between traffic volumes and standard traveling speeds are defined, or the standard traveling speed may be determined by a predetermined arithmetic formula. Alternatively, the standard traveling speed may be determined based on a traffic volume measured by a traffic volume measuring means provided separately. Still alternatively, the standard traveling speed may be set artificially.

Next, image processing is continuously performed on the video signal from the vehicle detection sensor CSi, and when a vehicle has been detected at a predetermined location on the screen corresponding to the location of the vehicle detection sensor on the road (S104), vehicle train detection processing executed as the vehicle train detection means 104 is performed (S106).

The vehicle train detection processing further performs image processing on the image acquired when the vehicle has been detected at the predetermined location on the screen to thereby obtain a length of a vehicle train in which vehicles range with each other within a fixed inter-vehicle distance from the detected vehicle. The vehicle train length is converted from the length of the vehicle train on the screen obtained through the image processing into a length on the road based on spatial arrangement of the vehicle detection sensor.

Note that in this embodiment, it is enough that the television camera of the vehicle detection sensor CSi has an angle of view that can detect a vehicle train of a length over the predetermined packet length. If the vehicle train is formed beyond the angle of view of the television camera, the vehicle train is assumed to have a length of the full angle of view of the television camera for convenience.

When a vehicle train having a longer length than the predetermined length has been detected through the vehicle train detection processing (S108), it is judged that vehicles from the top to the predetermined length form a packet, and thus packet traveling control processing is executed as the packet traveling control means 108 is performed (S110).

Details of the packet traveling control processing will be described later.

Next, when the vehicle train having a longer length than the predetermined length has been detected, a decelerating speed command are indicated to following vehicles within a certain range beyond the predetermined length from the head of the vehicle train so that the predetermined inter-vehicle train distance is formed at the next vehicle detection sensor (S112).

The speed command vd indicated to the following vehicles is obtained by a following formula:

vd=(dc/(dc+lg))*vs,

where vs is the speed command indicated to the preceding packet, dc is the distance up to the next vehicle detection sensor, and lg is the inter-vehicle train distance to be formed.

The processing above is repeated starting with S104 until elapse of predetermined time. If the predetermined time has elapsed (S118), the processing returns to S102. Here, the predetermined time is a cycle in which the standard traveling speed is reset according to variation in a traffic volume.

In S108, if the vehicle train having a longer length than the predetermined length has not been detected, the standard speed command is indicated to the vehicles concerned (S114), and an accelerating speed command is indicated to following vehicles within a certain range so that they catch up the preceding vehicle train at the next vehicle train detection sensor (S116), and then the processing precedes to S118.

The speed command va indicated to the following vehicles is obtained by a following formula:

va=(dc/(dc−ld))*vs,

where vs is the speed command indicated to the preceding packet, dc is the distance up to the next vehicle detection sensor, and ld is the inter-vehicle distance from a tail end of the preceding vehicle train.

Here, a speed permitted to be given as the accelerating speed command may be up to a legal speed at maximum, and an accelerating speed command beyond the legal speed may not be indicated.

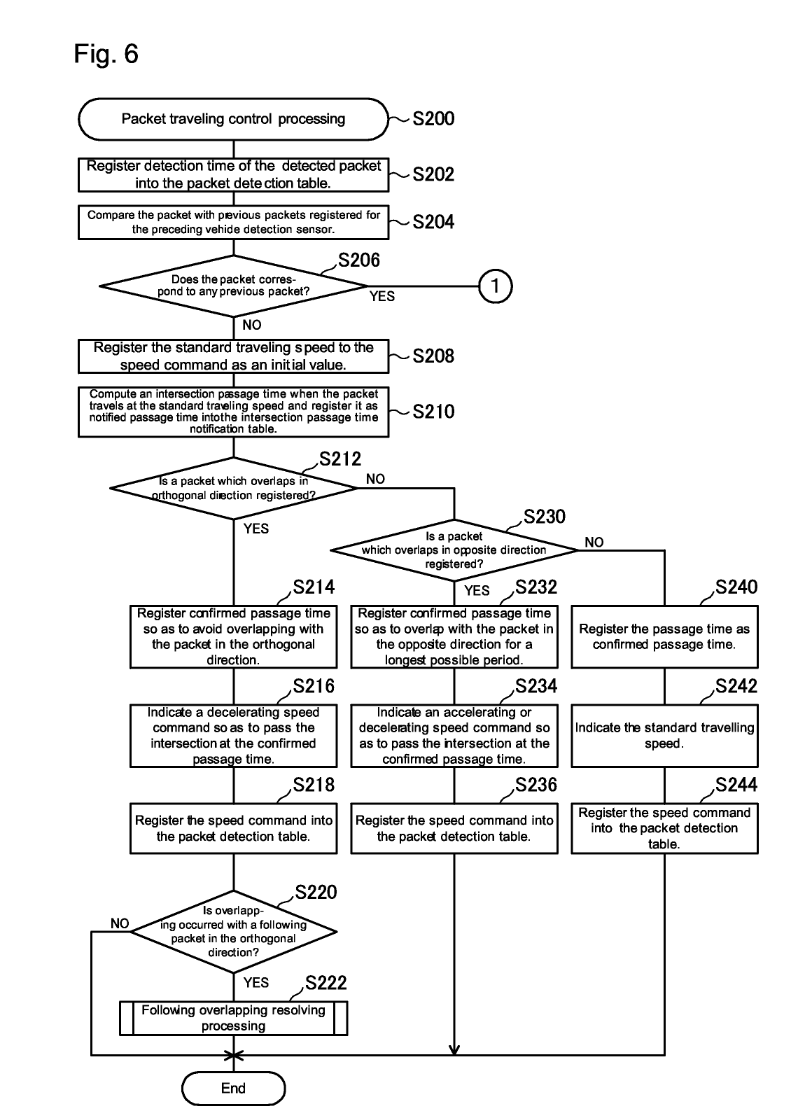

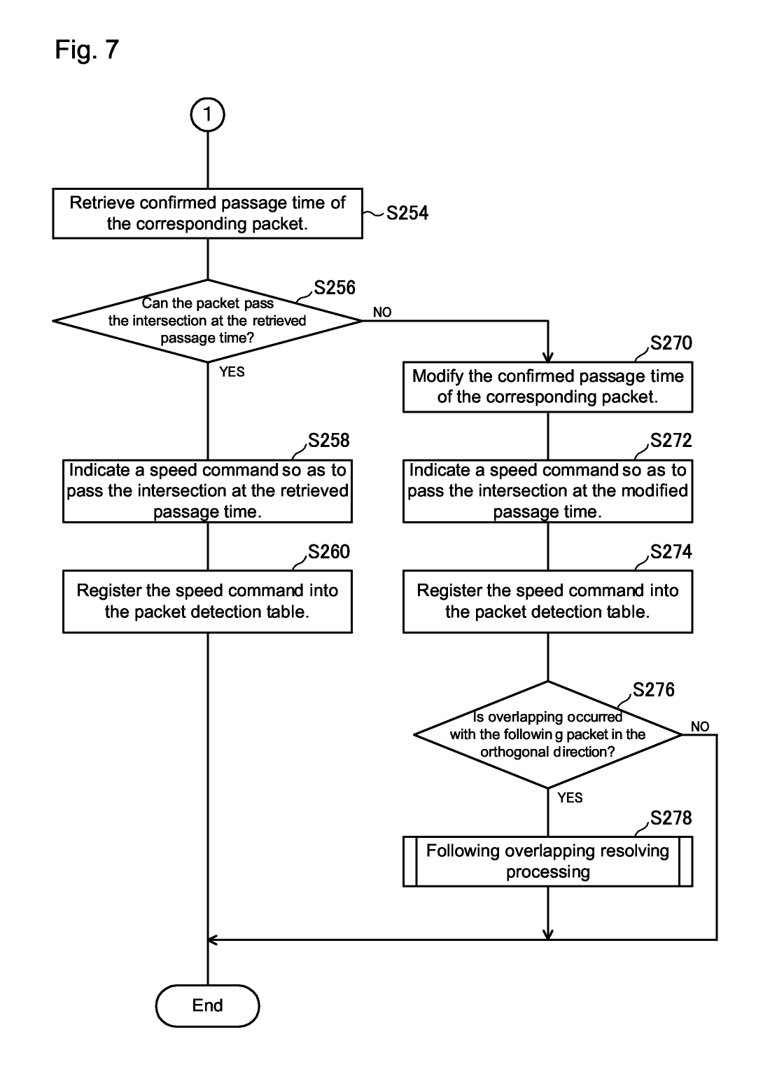

FIGS. 6 and 7 show procedures of packet traveling control processing S200 executed as the packet traveling control means 108 in the packet traffic control device 100. This packet traveling control processing S200 is executed in a case where a traffic signal at an intersection is variably controlled by the traffic signal control means 114 in the packet traffic control device 100.

As shown in the figure, first, detection time of the detected packet is registered into the packet detection table (S202), and the detected packet is compared with previous packets registered for the preceding vehicle detection sensor (S204). Specifically, estimated arrival time at which each of the previous packets reaches the vehicle detection sensor concerned is obtained based on the detection time, the specified speed command, and the distance between the preceding vehicle detection sensor and the vehicle detection sensor concerned, and it is compared with the detection time of the present packet detected at the vehicle detection sensor concerned.

If the detection time of the packet detected at the vehicle detection sensor concerned is within a predetermined range with reference to the estimated arrival time of any one of the previous packets, it is judged that the packet detected at the vehicle detection sensor concerned corresponds to one of the previous packets (S206), and then the processing proceeds to S254.

If it is judged in S206 that the packet detected at the vehicle detection sensor concerned does not correspond to any one of the previous packets, the standard traveling speed is registered as an initial value of the speed command for the detected packet (S208), and then estimated intersection passage time at which the detected packet passes the next intersection when it travels at the standard traveling speed is computed and registered as notified passage time into the intersection passage time notification table for the next intersection (S210).

Here, the intersection passage time represents time from time when a head of a packet reaches the intersection to time when a tail end of the packet passes the intersection when the packet passes through the intersection at the specified speed, and it is obtained based on the distance from the vehicle detection sensor at which the packet has been detected to the intersection, the specified traveling speed command, and the vehicle train length of the detected packet. Note that predetermined margin may be provided for the estimated intersection passage time, considering, for example, variation in the traveling speed of the vehicles forming the packet.

Next, it is checked whether or not passage time of a packet in an orthogonal direction to the detected packet is registered in the intersection passage time notification table, and if confirmed passage time of the packet in the orthogonal direction which overlaps with the notified passage time of the detected packet is registered (S212), the passage time of the detected packet is modified so as not to overlap with the confirmed passage time of the packet in the orthogonal direction and registered as confirmed passage time into the intersection passage time notification table (S214). A traveling speed so as to make the detected packet pass the intersection at the confirmed passage time is computed and the computed speed command is indicated to the vehicles forming the detected packet (S216). The speed command is registered into the packet detection table (S218).

If overlapping with confirmed passage time of another packet in the orthogonal direction occurs as a result of the processing of modifying the passage time described above (S220), the processing of modifying the confirmed passage time is carried out until overlapping with all confirmed passage time in the orthogonal direction is resolved through following overlapping resolving processing (S222), and then packet traveling control processing ends.

Note that upon determining the passage time so as not to overlap with the packet in the orthogonal direction, a certain period of blank time may be provided so that time is insured which permits right-turning vehicles included in the packet, if any, to make right-turn.

If there is no overlapping packet in the orthogonal direction in S212, it is checked whether or not passage time of a packet in an opposite direction to the detected packet is registered, and if the confirmed passage time of the packet in the opposite direction overlapping with the notified passage time of the detected packet is registered (S230), the passage time of the detected packet is modified so as to overlap with the confirmed passage time of the packet in the opposite direction for a longer period by indicating an accelerating or decelerating speed command within a possible range to the detected packet and registered as confirmed passage time into the intersection passage time notification table (S232). A traveling speed so as to make the detected packet pass the intersection at the confirmed passage time is computed and the computed speed command is indicated to the vehicles forming the detected packet (S234), the speed command is registered into the packet detection table (S236), and then the packet traveling control processing ends.

If there is no overlapping packet in the opposite direction, the notified passage time of the detected packet is registered as confirmed passage time into the intersection passage time notification table (S240), a speed command of the standard traveling speed is indicated to the vehicles forming the packet (S242), the speed command is registered into the packet detection table (S244), and then the packet traveling control processing ends.

If it is judged in S206 that the detected packet corresponds to one of the previous packets in the packet detection table, confirmed passage time of the corresponding packet registered in the intersection passage time notification table is retrieved (S254). It is judged whether or not the detected packet can pass the intersection at the retrieved confirmed passage time as a result of indicating an accelerating or decelerating speed command within a possible range to the detected packet, and if it is judged that the detected packet can pass the intersection at the retrieved confirmed passage time (S256), a traveling speed so as to make the detected packet pass the intersection at the retrieved confirmed passage time is computed and the computed speed command is indicated to the vehicles forming the detected packet (S258), the speed command is registered into the packet detection table (S260), and then the packet traveling control processing ends.

If it is judged in S256 that the detected packet cannot pass the intersection at the retrieved confirmed passage time, the confirmed passage time of the corresponding packet registered in the intersection passage time notification table is modified within a possible range (S270), a traveling speed so as to make the detected packet pass the intersection at the modified confirmed passage time is computed and the computed speed command is indicated to the vehicles forming the detected packet (S272), and the speed command is registered into the packet detection table (S274).

If overlapping with confirmed passage time of another following packet in the orthogonal direction occurs as a result of processing of modifying the packet passage time described above (S276), the processing of modifying the confirmed passage time is carried out until overlapping with all the confirmed passage time in the orthogonal direction is resolved through the following overlapping resolving processing (S278), and the packet traveling control processing ends.

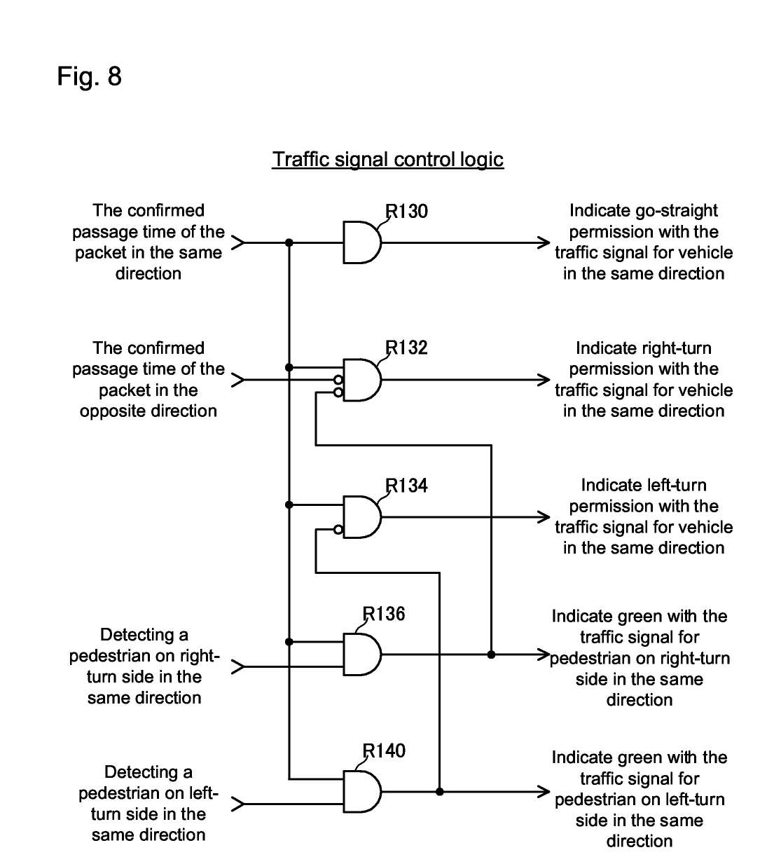

FIG. 8 shows an example of a traffic signal control logic executed as the traffic signal control means 114 in the packet traffic control device 100.

According to the traffic signal control logic, when a packet in the same direction as that of the traffic signal for vehicle is registered in the intersection passage time notification table, go-straight permission is indicated with the traffic signal for vehicle in confirmed passage time of a packet in the same direction (R130). Besides, not in the confirmed passage time of a packet in the orthogonal direction but when a traffic signal for pedestrian on a right-turn side in the same direction as that of the traffic signal for vehicle is red in the confirmed passage time in the same direction, right-turn permission is indicated with the traffic signal for vehicle (R132). Besides, when a traffic signal for pedestrian on a left-turn side in the same direction as that of the traffic signal for vehicle is red in the confirmed passage time of the packet in the same direction, left-turn permission is indicated with the traffic signal for vehicle (R134). Besides, when a pedestrian on the right-turn side in the same direction as that of the traffic signal for vehicle is detected by the pedestrian detection sensor in the confirmed passage time of the packet in the same direction, green signal is indicated with the traffic signal for pedestrian on the right-turn side (R136). And besides when a pedestrian on the left-turn side in the same direction as that of the traffic signal for vehicle is detected by the pedestrian detection sensor in the confirmed passage time of the packet in the same direction, green denotation is indicated with the traffic signal for pedestrian on the left-turn side (R140).

Here, pedestrian detection time to be entered at R136 and R140 represents time from time when pedestrians are detected by the pedestrian detection sensor to time when predetermined time required for the pedestrians to cross the intersection has passed. This is intended to indicate the traffic signal for pedestrian green signal until the pedestrians complete crossing the intersection, but the green signal may blink for the predetermined time.

Moreover, the confirmed passage time of the packet in the direction to be entered at R140 represents time from start time of the confirmed passage time of the packet to a certain time before end time thereof. This is intended to ensure time that permits left-turning vehicles included in this packet, if any, to make turn left.

By the logic above, the traffic signal for vehicle and the traffic signals for pedestrian are adequately controlled at each intersection based on the passage time of the packets from the different directions and condition of pedestrians detected at each intersection.

Note that the above traffic signal control logic shows a basic concept of the traffic signal control means in the present invention, and control is practically carried out in accordance with various traffic conditions, although detailed descriptions thereof are omitted here.

FIG. 4 illustrates how the notified passage time of the packet from each direction is adjusted at each intersection through the packet traveling control processing and the traffic signal control logic described above and how the traffic signals at each intersection are controlled based on the modified confirmed passage time therethrough.

First, passage time of an east-bound packet is notified (1), and since no overlapping packet is registered at this point, this notified passage time becomes confirmed passage time. Next, passage time of a west-bound packet is notified (2), and since it overlaps with the registration of the opposite east-bound packet at this point, an accelerating speed command is indicated within a possible range in order that the overlapping occurs for a longest possible period and confirmed passage time is registered. Next, passage time of a north-bound packet is notified (3), and since it overlaps with the registration of the orthogonal west-bound packet at this point, a decelerating speed command is indicated in order to avoid the overlapping and confirmed passage time is registered. Next, passage time of a south-bound packet is notified (4), and since it overlaps with the registration of the orthogonal west-bound packet in the same manner at this point, a decelerating speed command is indicated in order to avoid the overlapping and confirmed passage time is registered. Next, passage time of another east-bound packet is notified (5), and since it overlaps with the registration of the orthogonal south-bound and north-bound packets at this point, a decelerating speed command is indicated in order to avoid the overlapping and confirmed passage time is registered. Next, passage time of another west-bound packet is notified (6), and since it overlaps with the registration of the opposite east-bound packet at this point, an accelerating speed command is indicated within a possible range in order that the overlapping occurs for a longest possible period and confirmed passage time is registered. Next, passage time of the other east-bound packet is notified (7), and since no overlapping packet is registered at this point, the notified passage time becomes confirmed passage time. Next, passage time of another south-bound packet is notified (8), and since it overlaps with the registration of the orthogonal east-bound packet at this point, a decelerating speed command is indicated to avoid the overlapping and confirmed passage time is registered. Next, passage time of another north-bound packet is notified (9), and since it overlaps with the registration of the orthogonal east-bound packet at this point, a decelerating speed command is indicated to avoid the overlapping and confirmed passage time is registered. Next, passage time of a further west-bound packet is notified (10), and since it overlaps not only with the registration of the orthogonal south-bound and north-bound packets but also with the registration of the opposite east-bound packet at this point, but the overlapping with the registration of the orthogonal south-bound and north-bound packets can not be resolved by indicating the accelerating speed command, a decelerating speed command is indicated in order to avoid the overlapping with the registration of the packet in the orthogonal direction and confirmed passage time is registered. Next, passage time of a further east-bound packet is notified (11), and since it overlaps with the registration of the opposite west-bound packet at this point, a decelerating speed command is indicated in order that the overlapping occurs for a longest possible period and confirmed passage time is registered.

Note that the procedures of modifying confirmed passage time when a packet corresponding to the already registered packet detected by the preceding vehicle detection sensor is omitted from the illustration in FIG. 4 since presenting the case on the illustration is so complicated.

Moreover, the control of the traffic signals is carried out in the following manner based on the above determined confirmed passage time of the packet from each direction.

The traffic signal for east-bound vehicle indicates go-straight permission in the confirmed passage time of the east-bound packet, indicates right-turn permission not in the confirmed passage time of the west-bound packet but when the traffic signal for pedestrian on south side in east-west direction does not indicate green (walk) in the confirmed passage time of the east-bound packet, and indicates left-turn permission when the traffic signal for pedestrian on north side in east-west direction does not indicate green in the confirmed passage time of the east-bound packet.

The traffic signal for west-bound vehicle indicates go-straight permission in the confirmed passage time of the west-bound packet, indicates right-turn permission not in the confirmed passage time of the east-bound packet but when the traffic signal for pedestrian on north side in east-west direction does not indicate green in the confirmed passage time of the west-bound packet, and indicates left-turn permission when the traffic signal for pedestrian on west side in east-west direction does not indicate green in the confirmed passage time of the west-bound packet.

The traffic signal for south-bound vehicle indicates go-straight permission in the confirmed passage time of the south-bound packet, indicates right-turn permission not in the confirmed passage time of the north-bound packet but when the traffic signal for pedestrian on east side in south-north direction does not indicate green in the confirmed passage time of the south-bound packet, and indicates left-turn permission when the traffic signal for pedestrian on west side in south-north direction does not indicate green in the confirmed passage time of the south-bound packet.

The traffic signal for north-bound vehicle indicates go-straight permission in the confirmed passage time of the north-bound packet, indicates right-turn permission not in the confirmed passage time of the south-bound packet but when the traffic signal for pedestrian on west side in south-north direction does not indicate green in the confirmed passage time of the north-bound packet, and indicates left-turn permission when the traffic signal for pedestrian on east side in south-north direction does not indicate green in the confirmed passage time of the north-bound packet.

The traffic signal for pedestrian on south side in east-west direction indicates green (walk) in the confirmed passage time of the east-bound or west-bound packet when a pedestrian on south side in east-west direction is detected.

The traffic signal for pedestrian on north side in east-west direction indicates green in the confirmed passage time of the east-bound or west-bound packet when a pedestrian on north side in east-west direction is detected.

The traffic signal for pedestrian on north side in south-north direction indicates green in the confirmed passage time of the south-bound or north-bound packet when a pedestrian on east side in south-north direction is detected.

The traffic signal for pedestrian on west side in south-north direction indicates green in the confirmed passage time of the south-bound or north-bound packet when a pedestrian on west side in south-north direction is detected.

In the above embodiment, it is described that in the traffic signal control logic, the traffic signal for pedestrian is controlled upon detection of presence of a predetermined or more amount of pedestrians waiting for crossing in the direction concerned based on information from the pedestrian detection sensor. Alternatively, a function may be provided which obtains a roughly estimated number of pedestrians in the pedestrian grasping means and varies time during which the traffic signal for pedestrian indicates green based on the estimated number of pedestrians.

Moreover, in the above embodiment, it is described that the pedestrian detection at each intersection is carried out by the pedestrian detection sensor. Alternatively, a crosswalk button may be provided separately for each cross direction and when the crosswalk button is pressed, it may be assumed that presence of any pedestrian has been detected.

In the above embodiment, since the traffic signals at each intersection are controlled according to vehicles traveling while forming a packet, the traffic signal for pedestrian has an irregular indication cycle, thus it may cause problems that a pedestrian cannot estimate how long he or she has to wait until crossing is permitted and in how much time he or she has to finish crossing.

Alternatively, a digital display function may be provided with which the traffic signal for pedestrian not only simply indicates green or red but also indicates waiting time for crossing such as “You can cross in X seconds” when the traffic signal for pedestrian is red and/or indicates remaining time for crossing such as “Please cross in Y seconds” when the traffic signal for pedestrian is green.

Such a digital display function can easily be achieved in the traffic signal control means by acquiring planned time at which the next green signal is indicated and/or end time of the current green signal upon controlling the traffic signal for pedestrian based on the confirmed passage time of the packet from each direction registered in the intersection passage time notification table, and then displaying a difference time between current time and the acquired time digitally.

Performing such digital display permits the pedestrian to recognize how long he or she has to wait until the next time when crossing is permitted and in how much time he or she has to finish crossing, which prevents frustration or confusion from being caused in the pedestrian.

The traffic signal control logic of the above embodiment is assumed to apply for an intersection which a pedestrian crosses. Alternatively, for an intersection which no pedestrian crosses, it is enough to indicate go-straight permission in the traffic signal for vehicle in the confirmed passage time of the packet in the same direction and indicate right-turn permission in the same traffic signal for vehicle not in confirmed passage time of a packet in the opposite direction in the confirmed passage time of the packet in the same direction.

In the above embodiment, since time at which it passes the intersection is not adjusted for a vehicle not having a predetermined vehicle train length, such vehicle is basically stopped at the next intersection. Alternatively, even for a vehicle train not having the predetermined vehicle train length, the traffic signal for vehicle may be controlled so as to make the vehicle train pass an intersection when confirmed passage time of a packet in the orthogonal direction is not registered at time when the vehicle train will pass the intersection.

Still alternatively, in the packet traveling control processing, when a vehicle being stopped at an intersection for a certain period or longer has been detected, confirmed passage time of a packet in the same direction of the vehicle may be registered into the intersection passage time notification table for convenience and then control may be performed so as to make the vehicle pass the intersection.

In the above embodiment, since the pedestrian can cross the intersection only in passage time of a packet in the direction same as the direction in which the pedestrian makes crossing, the pedestrian has to wait at the intersection for all the time when there is no packet in the same direction. Alternatively, the traffic signal for pedestrian may be controlled so as to permit the pedestrian detected by the pedestrian detection sensor to cross the intersection when confirmed passage time of a packet in the orthogonal direction to the crossing direction of the pedestrian is not registered.

Moreover, in the packet traveling control processing, in order that the pedestrian detected by the pedestrian detection sensor can cross the intersection when a certain period has elapsed since the pedestrian was detected by the pedestrian detection sensor, confirmed passage time of a packet in the same direction as the crossing direction of the pedestrian may be registered into the intersection passage time notification table for convenience and control may be performed so as to permit the pedestrian to pass the intersection.

In the above embodiment, in the packet formation control processing, the packet traveling control processing is activated when a packet having a longer length than the predetermined length has been detected so that the packet formation control processing and the vehicle train detection processing are performed simultaneously. Needless to say, the vehicle train detection processing may be provided independently from the packet formation control processing.

In the above embodiment, it is described that in the packet formation control processing, the standard traveling speed is indicated to the vehicles concerned when no vehicle train having a longer length than the predetermined length is formed. Alternatively, the vehicles not forming a vehicle train having a longer length than the predetermined length may be made freely travel.

Moreover, in the above embodiment, in the packet formation control processing, it is assumed that, when no vehicle train having a longer length than the predetermined length is formed, an accelerating speed command is indicated to following vehicles within a certain range so that they can catch up the preceding vehicle train at the next signal. However, since the intersection priority passage processing may not be performing on the preceding vehicle train until a packet is formed and thus the preceding vehicle train may be stopped at the traffic signal and generate a packet by absorbing the following vehicles, the accelerating speed command is not necessarily indicated and thus may be omitted.

Moreover, in the above embodiment, in the packet formation control processing, it is assumed that, when any vehicle train having a longer length than the predetermined length has been detected, a decelerating speed command is indicated to the vehicles in the vehicle train beyond the predetermined length from the head so that the predetermined inter-vehicle train distance is formed with the preceding vehicle train at the next vehicle detection sensor. However, the predetermined inter-vehicle train distance is not necessarily formed at the next vehicle detection sensor, and thus a function of measuring the inter-vehicle train distance together with the vehicle train length at each vehicle detection sensor may be provided and a speed command may be indicated so that the predetermined vehicle train length and the predetermined inter-vehicle train are formed gradually.

In the above embodiment, it is described that in the packet traveling control processing, the notified passage time is registered into the intersection passage time notification table and the adjustment of the passage time with another packet is made. However, the notified passage time is provided for convenience in the above description, and it is needless to say that the passage time of the packet may be adjusted by comparing the passage time of the packet to be registered directly with the passage time of another packet already registered.

Moreover, in the above embodiment, in the packet traveling control processing, it is assumed that the packet detection table into which a packet is registered when detected at each vehicle detection sensor is provided, correspondence with a packet detected at the preceding vehicle detection sensor is judged when a packet has been detected, and then it is determined whether to newly register the packet into the intersection passage time notification table or to modify passage time of an already registered packet. However, the packet detection table is not necessarily required to check correspondence with an already registered packet, and thus a location of the vehicle detection sensor which has detected a packet, detection time, and an indicated speed command specified for the packet may be registered into the intersection passage time notification table upon registering passage time of the packet.

In the above embodiment, it is omitted from the description what will be done in a case where the packet detected at the preceding vehicle detection sensor disappears at the next vehicle detection sensor. Processing may be performed which computes arrival time at the next vehicle detection sensor based on the detected time and the specified indicated speed command of the packet registered at the preceding vehicle detection, and if no packet has been detected at the next vehicle detection sensor within predetermined time with reference to the computed arrival time, deletes the confirmed passage time of the packet from the intersection passage time notification table as the packet has disappeared.

In the above embodiment, it is not specified how each of the traffic signals indicates not in passage time of a packet and when no pedestrian has been detected. However, it is desirable that the traffic signal for vehicle and the traffic signals for pedestrian provide full red indication in a standby state and change to green indication when passage time of a packet has been reached or when any pedestrian has been detected.

This is based on an idea that, in a case where green indication is provided in a standby state, a vehicle not forming a packet may be suddenly stopped as a result of packet passage or pedestrian detection when the vehicle tries to enter the intersection and also there is a risk of accident as a result of forceful passage through the intersection by a vehicle or a pedestrian.

In the above embodiment, it is described that after adjusting passage time at which a packet from each direction passes the intersection, the traffic signals at each intersection are variably controlled in accordance therewith. However, the traffic signals at the intersection may be controlled in a fixed cycle.

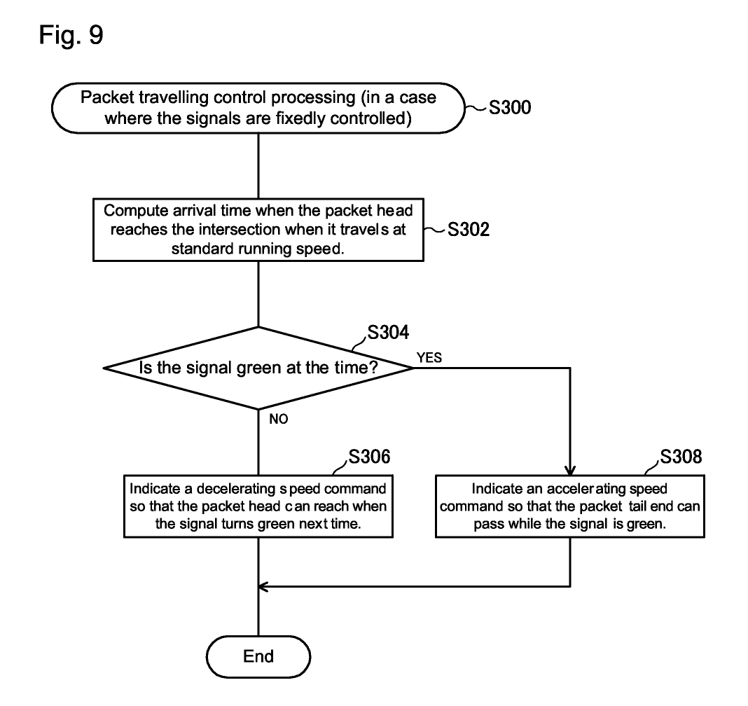

FIG. 9 shows procedures of packet traveling control processing S300 in a case where the traffic signals are fixedly controlled.

In the packet traveling control processing S300 in the case where the traffic signals are fixedly controlled, first, arrival time at which the detected packet reaches the next intersection when it travels at the standard traveling speed is computed (S302). When the traffic signal for vehicle at the intersection in the travel direction is red at the arrival time (S304), a speed command is indicated so that a head of the detected packet can reach the intersection at time at which the traffic signal turns green next time (S306). When the traffic signal for vehicle at the intersection in the traveling direction is green at the arrival time, a speed command is indicated so that a tail end of the detected packet can pass the intersection while the traffic signal is green (S308), and the packet traveling control processing ends.

As a result, also in the case where the traffic signals of the intersection are fixedly controlled, a speed command is indicated so that the formed packet can efficiently pass the intersection within a possible range, thus giving the driver incentive to observe the speed command, which suppresses occurrence of natural traffic jam.

In the above embodiment, it is described referring to a case where the road has one lane on one side, although not limited thereto, and the system is applicable to a road having plurality of lanes on one side. In the latter case, for example, a vehicle detection sensor and a traveling speed command indicator may be provided for a specific lane and packet formation control and packet traveling control may be made for vehicles in the specific lane, while those in the other lanes are made travel freely. Alternatively, a vehicle detection sensor and a traveling speed command indicator may be provided for each of the lanes and packet formation control and packet traveling control may be made independently for each of the lanes. Moreover, a vehicle train formed by all the vehicles in the plurality of lanes may be detected by a vehicle detection sensor and a speed command may be indicated to the vehicles in the plurality of lanes at one time by a speed command indicator, thereby guiding them to travel while forming a packet having a predetermined vehicle train length and a predetermined inter-vehicle train as a whole.

In the above embodiment, it is described that the traveling speed command indicator is disposed along the road. Alternatively, a specified traveling speed may be transmitted directly to vehicles on the road from a beacon provided along the road and it may be displayed on, for example, a car navigator provided in each vehicle, or the traveling speed of each vehicle may be automatically controlled based on the specified traveling speed command received from the beacon.

Moreover, a function may be provided which acquires condition of a direction indicator from each of the vehicles on the road and controls the traffic signals based on the condition of the direction indicator acquired from each of the vehicles passing the intersection.

Moreover, by acquiring the condition of the direction indicator from each of the vehicles on the road, information on bypass road may be created based on a traffic volume in the traveling direction to indicate on a car navigation device or else in each of the vehicles.

Moreover, in a case where route information is previously registered in the car navigation device of each of the vehicles, the registered route information may be acquired and the intersection passage time may be adjusted based on the acquired route information. This makes it possible to adjust passage time for a following intersection after direction change in advance, thus permitting packet traveling to be more efficiently controlled.

Moreover, for a destination previously registered in the car navigation device of each of the vehicles, by referring to the confirmed passage time of a packet in an orthogonal direction at an intersection through which the vehicle is scheduled to pass, the route through which the vehicle can pass most efficiently can be provided from the car navigation device.

As described above, by linking the car navigation device of each vehicle with the packet traffic control system of the present invention, the traffic control system can be constructed more efficiently.

In the above embodiment, handling of a case where an emergency vehicle such as an ambulance vehicle or a fire-extinguishing vehicle passes is omitted from the description. The packet traffic control device may be provided with an emergency vehicle traveling information acquiring means for acquiring traveling information such as a destination or a route of an emergency vehicle, and processing may be added which registers scheduled time at which the emergency vehicle passes the intersection at a predetermined speed into the intersection passage time notification table and modifies the already registered confirmed passage time of the packet overlapping with the registered passage time of the emergency vehicle for each intersection on the route based on the acquired traveling information of the emergency vehicle.

Since the emergency vehicle can basically pass an intersection regardless of a indication of the traffic signal for vehicle, the emergency vehicle can travel without control of the traffic signal at the intersection on the traveling route, and it is thought that disturbance of packet traveling caused by the passage of the emergency vehicle is autonomously recovered by the subsequent packet formation control processing. However, as described above, by registering the passage time into the intersection passage time notification table for the intersection through which the emergency vehicle is scheduled to pass and then adjusting the already registered passage time of the packet, the emergency vehicle can travel more smoothly and influence given to the vehicles traveling while forming the packet can be minimized.

### INDUSTRIAL APPLICABILITY

As described above, according to the present invention, a traffic control system is provided which is capable of indicating a speed command to vehicles on a road to thereby make the vehicles travel while forming a packet having a predetermined vehicle train length and a predetermined inter-vehicle train distance and thus suppressing unnecessary stop and go and/or acceleration and deceleration to thereby not only achieve improvement of fuel efficiency, suppression of environmental pollution and reduction of traffic noise, but also suppress occurrence of natural traffic jam to prevent occurrence of traffic accidents associated with frustrated driving, etc.

The present invention is not limited to the preferred embodiment described above, and the components described in the preferred embodiments may be replaced as appropriate, a new component may be added, and part of the components may be deleted, as far as providing the advantage of the present invention.

1. A packet traffic control system including:
a vehicle detection means disposed along a road for detecting a vehicle on the road;
a traveling speed command indication means disposed along the road for indicating a traveling speed command to the vehicle on the road;
a vehicle train detection means for detecting a vehicle train in which vehicles detected by the vehicle detection sensor range with each other within a predetermined length; and
a packet formation control means for indicating a traveling speed command so that the vehicle train detected by the vehicle train detection means forms a vehicle train having a predetermined vehicle train length and a predetermined inter-vehicle train distance (hereinafter referred to as “packet”) to the vehicle on the road by the traveling speed command indication means.

2. The packet traffic control system according to claim 1, including a standard traveling speed determination means for determining a standard traveling speed in each travel direction based on a number of vehicles detected by the vehicle detection means per predetermined time period,
wherein the packet formation control means includes
a function of indicating the standard traveling speed in the travel direction determined by the standard traveling speed determination means as an initial traveling speed command to vehicles within the predetermined vehicle train length from a head of a vehicle train and indicating a decelerating speed command so as to form the predetermined inter-vehicle train distance from the preceding vehicle train to following vehicles beyond the predetermined vehicle train length from the head of the vehicle train by the traveling speed command indication means, when the vehicle train having a longer length than the predetermined length is detected by the vehicle train detection means when a vehicle is detected by the vehicle detection means.

3. The packet traffic control system according to claim 2,
wherein the function of indicating a decelerating speed command so as to form the predetermined inter-vehicle train distance computes and indicates a traveling speed at which the predetermined inter-vehicle train distance is formed at the next vehicle detection means disposed in the traveling direction to the vehicles beyond the predetermined vehicle train length from the head of the vehicle train.

4. The packet traffic control system according to claim 3,
wherein the packet formation control means includes
a function of computing and indicating a traveling speed at which following vehicles catch up a preceding vehicle train at the next vehicle detection means disposed in the traveling direction to following vehicles within a certain range by the traveling speed command indication means, when the vehicle train having a longer length than the predetermined length is not detected by the vehicle train detection means.

5. The packet traffic control system according to claim 1, including an intersection passage time notification table for notifying time at which a packet from each direction passes at each intersection, a packet traveling control means for controlling a packet traveling, and a traffic signal control means for controlling a traffic signal, wherein the packet traveling control means includes:
a function of computing passage time at which a packet passes a next intersection when the packet travels at the indicated traveling speed, when the packet is detected by the vehicle train detection means;
a function of registering the computed passage time into the intersection passage time notification table for the intersection, when no packet overlapping with the computed passage time is registered;
a function of modifying the computed passage time to passage time not overlapping with a packet in the orthogonal direction, registering the modified passage time into the intersection passage time notification table for the intersection, and then indicating a traveling speed command at which the packet passes the intersection at the modified passage time to the vehicles forming the packet by the traveling speed command indication means, when the packet overlapping with the computed passage time is registered in the orthogonal direction; and
a function of modifying the computed passage time to passage time overlapping with the packet in the orthogonal direction for a longest possible period, registering the modified passage time into the intersection passage time notification table for the intersection, and then indicating a traveling speed at which the packet passes the intersection at the modified passage time to the vehicles forming the packet by the traveling speed command indication means, when a packet overlapping with the computed passage time is registered in an opposite direction; and
wherein the traffic signal control means includes
a function for controlling the traffic signals at each intersection based on the passage time of the packet from each direction registered in the intersection passage time notification table.

6. The packet traffic control system according to claim 5, including a packet detection table in which at least detection time and a speed command of the packet detected by the vehicle train detection means are registered,
wherein the packet traveling control means includes:
a function of retrieving passage time of a corresponding packet registered in the intersection passage time notification therefrom, where a previous packet registered in the packet detection table for the preceding vehicle detection means disposed in front of the vehicle detection means detecting the present packet in the traveling direction is assumed as the corresponding packet when the detection time of the present packet detected by the vehicle train detection means is within a predetermined range with reference to estimated arrival time of the previous packet to the vehicle detection means detecting the present packet where the estimated arrival time is computed based on detection time and a speed command thereof;
a function of indicating a traveling speed command to the vehicles forming the present packet so as to pass the intersection at the retrieved passage time by the traveling speed command indication means when the present packet can pass the intersection at the retrieved passage time; and
a function of modifying the passage time in the intersection passage time notification table to closest passage time within a possible range and indicating a traveling speed command to the vehicles forming the present packet so as to pass the intersection at the modified passage time by the traveling speed command indication means when the present packet cannot pass the intersection at the retrieved passage time.

7. The packet traffic control system according to claim 6,
wherein the packet traveling control means includes
a function of repeatedly modifying passage time of a packet in the orthogonal direction to passage time not causing overlapping until overlapping of passage time with a new packet in the orthogonal direction no longer occurs when overlapping with passage time of the packet in the orthogonal direction occurs as a result of modifying passage time in the intersection passage time notification table.

8. The packet traffic control system according to claim 5,
wherein the traffic signal control means includes
a function of indicating go-straight permission with a traffic signal for vehicle in the passage time of the packet in the same direction and indicating right-turn permission with the traffic signal for vehicle when passage time of a packet in the opposite direction is not registered in the passage time of the packet in the same direction, when passage time of a packet in the same direction as that of the traffic signal for vehicle is registered in the intersection passage time notification table.

9. The packet traffic control system according to claim 5, including a pedestrian detection means disposed at each intersection for detecting a pedestrian crossing the intersection,
wherein the traffic signal control means includes:
a function of indicating go-straight permission with a traffic signal for vehicle in passage time of a packet in the same direction as that of the traffic signal for vehicle;
a function of indicating right-turn permission with the traffic signal for vehicle when it is not in passage time of a packet in the opposite direction but a traffic signal for pedestrian on a right-turn side in the same direction as that of the traffic signal for vehicle is red in the passage time of the packet in the same direction;
a function of indicating left-turn permission with the traffic signal for vehicle when a traffic signal for pedestrian on a left-turn side in the same direction as that of the traffic signal for vehicle is red in the passage time of the packet in the same direction;
a function of indicating green signal with a traffic signal for pedestrian on a right-turn side in the same direction as that of the traffic signal for vehicle when a pedestrian on the right-turn side in the same direction is detected by the pedestrian detection means in the passage time of the packet in the same direction; and
a function of indicating green signal with a traffic signal for pedestrian on a left-turn side in the same direction as that of the traffic signal for vehicle when a pedestrian on the left-turn side in the same direction is detected by the pedestrian detection means in the passage time of the packet in the same direction, when the passage time of the packet in the same direction is registered in the intersection passage time notification table.

10. The packet traffic control system according to claim 1, including a packet traveling control means for controlling a packet traveling, wherein the packet traveling control means includes
a function of computing a traveling speed at which a vehicle can pass a next intersection while the traffic signal is green and indicating the computed traveling speed command to the vehicles forming a packet by the traveling speed command indication means, when the packet is detected by the vehicle train detection means.
